(19) United States
(12) Patent Application Publication
(10) Pub. No.: US 2021/0276762 A1
(43) Pub. Date: Sep. 9, 2021

(54) VARIABLE FOOD PACKAGING CONTAINER

(71) Applicant: Yeong Nam Son, Busan (KR)

(72) Inventor: Yeong Nam Son, Busan (KR)

(21) Appl. No.: 17/254,577

(22) PCT Filed: Jun. 22, 2018
(86) PCT No.: PCT/KR2018/007106

§ 371 Date: Dec. 21, 2020

(51) Int. Cl. B65D 21/08; B65D 63/10; B65D 77/20

(52) U.S. Cl. CPC B65D 21/08; B65D 2577/20; B65D 77/20; B65D 63/10

(57) ABSTRACT

A variable food packaging container according to the present invention includes: a tray including a main body portion with an open side surface, an auxiliary expandable portion that is combined with the open side surface of the main body portion to form an accommodation space therewith, and a connector that allows the main body portion and the auxiliary expandable portion to be connected to each other so as to be able to be spaced apart from each other; and a cover film attached to the tray to cover the accommodation space. The main body portion and the auxiliary expandable portion are combined in a form of partially overlapping each other, in a state in which the main body portion and the auxiliary expandable portion partially overlap each other, the overlapping state is maintained by the cover film, and the auxiliary expandable portion is able to be spaced apart from the main body portion only when the cover film is removed. The connector is formed as a connecting film that is attached in a form of continuing along both side surfaces and a bottom surface of the main body portion and both side surfaces and a bottom surface of the auxiliary expandable portion. According to the present invention, since the accommodation space of the tray is expandable, contents may be taken out without damage thereto, and the level of brine that the accommodation space is filled with is lowered such that the contents may be taken out without causing overflow of the brine.

### TECHNICAL FIELD

The present invention relates to a variable food packaging container that is used for packaging food such as tofu and of which a volume is selectively expandable to allow contents to be easily taken out.

### BACKGROUND ART

Generally, among foods that are produced in large quantities in food factories and sold in stores, so-called soft foods such as tofu are enclosed in sealed packaging containers and distributed to prevent damage to the food during transportation and prevent evaporation of moisture from the food due to exposure to outside air.

As illustrated in FIG. 1, a conventional food packaging container includes a tray (5) that has an open upper surface and forms an accommodation space to hold contents and a cover film (7) that is attached to an upper surface of the tray (5) and selectively opened.

According to the related art, in a state in which contents such as tofu (3) are held in the accommodation space of the tray (5), the cover film (7) is attached to upper ends of the tray (5) to seal and package the contents.

Here, the tray (5) is filled with brine together with the tofu (3) so that the brine protects the tofu (3) from external impact, which is applied to the tray (5) during product transportation or the like, and prevents the external impact from being directly transmitted to the tofu (3) and so that the tofu (3) contains a certain amount of moisture continuously to maintain its commercial value.

According to the related art, due to the characteristic that the tofu (3) and the brine should be held together as contents, in consideration of this, a volume of the accommodation space of the tray (5) is configured to be greater than a volume of the tofu (3) by a predetermined value or more.

However, when the tray (5) is configured to have a form in which the volume of the accommodation space is too large, since the amount of brine that is used increases, the manufacturing cost of the product increases, and since the volume and weight of the product increase, the logistics cost due to transportation, storage, and the like also increase.

Therefore, in general, the tray (5) has a size that can accommodate the tofu (3) and only a minimum amount of brine to protect the tofu (3) from the external impact and allow the tofu (3) to maintain moisture.

However, according to the related art, since there is not much available space between the tray (5) and the tofu (3), in a process in which a user removes the cover film (7) and then puts his or her hand in the space between the tray (5) and the tofu (3) to take out the tofu (3), the tofu (3) may be damaged or the brine may overflow, thus causing inconvenience in use.

Furthermore, although it is possible to take out the tofu (3) without damage thereto when the tray (5) is flipped upside down, since the brine pours out completely as a result, there is a problem in that, in a case in which the user wants to cut and use only a portion of the tofu (3), the rest of the tofu is unable to be stored while being held in brine and thus is not preserved in an excellent condition.

### DISCLOSURE

### Technical Problem

The present invention is directed to providing a variable food packaging container that, due to a characteristic that a volume of a tray is selectively expandable, allows soft foods such as tofu accommodated therein as contents to be taken out conveniently.

### Technical Solution

A variable food packaging container according to the present invention includes: a tray including a main body portion that has a form in which one side surface is open, an auxiliary expandable portion that is combined with the open one side surface of the main body portion so as to be able to be spaced apart therefrom and to form a single accommodation space therewith, and a connector that allows the main body portion and the auxiliary expandable portion to be connected to each other so as to be able to be spaced apart from each other; and a cover film attached to the tray to cover the accommodation space.

The main body portion and the auxiliary expandable portion of the tray may be combined in a form of partially overlapping each other, in a state in which the main body portion and the auxiliary expandable portion partially overlap each other, the overlapping state may be maintained by the cover film, and the auxiliary expandable portion may be able to be spaced apart from the main body portion only when the cover film is removed.

The connector may be formed as a connecting film that is attached in a form of continuing along both side surfaces and a bottom surface of the main body portion and both side surfaces and a bottom surface of the auxiliary expandable portion, is folded in the state in which the main body portion and the auxiliary expandable portion partially overlap each other, and is unfolded when the auxiliary expandable portion is spaced apart from the main body portion to maintain a state in which the main body portion and the auxiliary expandable portion are connected.

Also, the variable food packaging container according to the present invention may include a binding tape that is attached to bind the main body portion and the auxiliary expandable portion to maintain the state in which the main body portion and the auxiliary expandable portion are combined while partially overlapping each other.

In addition, the connector may be formed as a bellows connecting portion configured in a form of continuing along both side surfaces and the bottom surface of the main body portion and both side surfaces and the bottom surface of the auxiliary expandable portion.

The bellows connecting portion may maintain a compressed state due to the cover film that is attached to upper ends of both the main body portion and the auxiliary expandable portion that constitute the tray.

The variable food packaging container according to the present invention may include a binding tape that is attached to bind the main body portion and the auxiliary expandable portion to more firmly maintain the state in which the bellows connecting portion is compressed.

### Advantageous Effects

According to a variable food packaging container of the present invention, due to a characteristic that an accommodation space of a tray is selectively expandable, contents can be taken out without damage thereto, the level of brine that the accommodation space is filled with is lowered such that the contents can be taken out without causing overflow of the brine, and, after only a portion of the contents is cut and easily taken out, the rest of the contents can be stored in excellent condition while being held in the brine as before. Also, since, before the tray is opened, the accommodation space of the tray is maintained to have a minimum volume necessary for storing the contents, efficiency of storage and transportation is not degraded.

### DESCRIPTION OF DRAWINGS

FIG. 1 is a perspective view illustrating a structure of a food packaging container according to the related art.

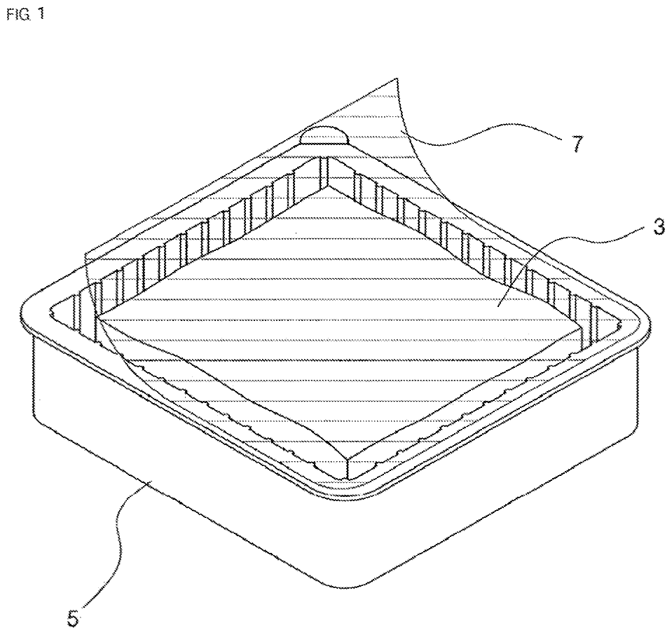

FIG. 2 is an exemplary view illustrating a structure of a variable food packaging container according to a first embodiment of the present invention and a state before the variable food packaging container is opened.

FIG. 3 is an exemplary view illustrating a structure in which a binding tape is provided on the variable food packaging container according to the first embodiment of the present invention and a state before the variable food packaging container is opened.

FIG. 4 is an exemplary view illustrating a state in which the variable food packaging container according to the first embodiment of the present invention is opened.

FIG. 5 is an exemplary view illustrating a state in which the variable food packaging container to which the binding tape is provided according to the first embodiment of the present invention is opened.

FIG. 6 is an exemplary view illustrating a structure of a variable food packaging container according to a second embodiment of the present invention and a state before the variable food packaging container is opened.

FIG. 7 is an exemplary view illustrating a state in which the variable food packaging container according to the second embodiment of the present invention is opened.

### MODES OF THE INVENTION

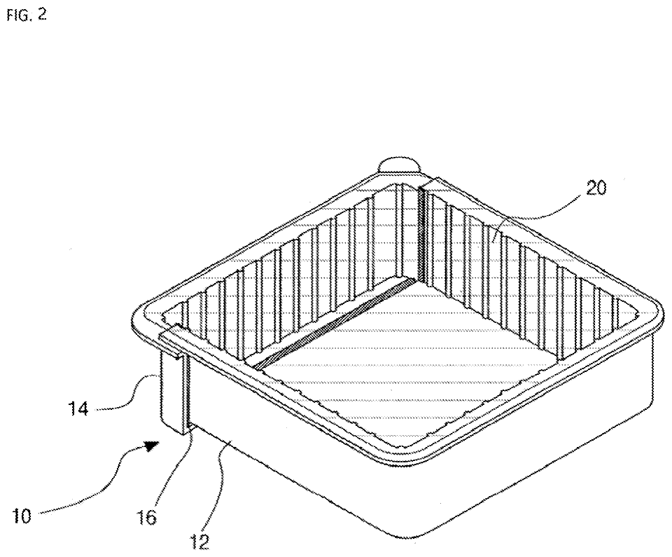

Details for embodying the present invention will be described with reference to FIGS. 2 to 7.

As illustrated in FIG. 2, a variable food packaging container according to a first embodiment of the present invention includes: a tray 10 including a main body portion 12 that has a form in which one side surface is open, an auxiliary expandable portion 14 that is combined with the open one side surface of the main body portion 12 so as to be able to be spaced apart therefrom and to form a single accommodation space therewith, and a connector that allows the main body portion 12 and the auxiliary expandable portion 14 to be connected to each other so as to be able to be spaced apart from each other; and a cover film 20 attached to the tray 10 to cover the accommodation space.

The main body portion 12 and the auxiliary expandable portion 14 of the tray 10 are combined in a form of partially overlapping each other, and in a state in which the main body portion 12 and the auxiliary expandable portion 14 partially overlap each other, the overlapping state is maintained by the cover film 20.

The connector is formed as a connecting film 16 that is attached in a form of continuing along both side surfaces and a bottom surface of the main body portion 12 and both side surfaces and a bottom surface of the auxiliary expandable portion 14, is folded in the state in which the main body portion 12 and the auxiliary expandable portion 14 partially overlap each other, and is unfolded when the auxiliary expandable portion 14 is spaced apart from the main body portion 12.

Here, for example, a structure in which the main body portion 12 and the auxiliary expandable portion 14 of the tray 10 partially overlap each other may have a form in which a front end of the main body portion 12 is placed inside the auxiliary expandable portion 14.

In the case in which the front end of the main body portion 12 is placed inside the auxiliary expandable portion 14, preferably, one side end of the connecting film 16 is attached to an inner side surface of the auxiliary expandable portion 14, and the other side end of the connecting film 16 is attached to an outer side surface of the main body portion 12.

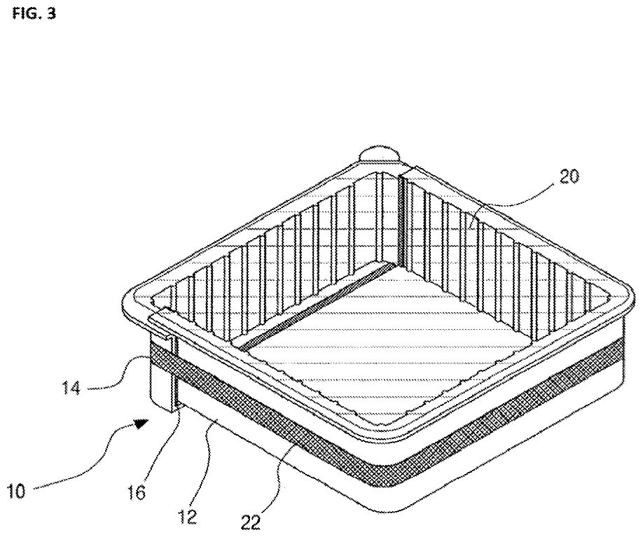

Also, as illustrated in FIG. 3, the variable food packaging container according to the present invention may include a binding tape 22 that is attached to bind the main body portion 12 and the auxiliary expandable portion 14 to firmly maintain the state in which the main body portion 12 and the auxiliary expandable portion 14 partially overlap each other.

For example, the binding tape 22 may be configured to be attached to side surfaces of the main body portion 12 and the auxiliary expandable portion 14 of the tray 10.

The operation of the variable food packaging container according to the first embodiment of the present invention that is configured as described above will be described below.

First, as illustrated in FIG. 2, in a state in which the tray 10 is not opened, since the cover film 20 is attached to upper ends of the main body portion 12 and the auxiliary expandable portion 14 in a state in which the main body portion 12 and the auxiliary expandable portion 14 partially overlap each other, the main body portion 12 and the auxiliary expandable portion 14 are bound to each other by the cover film 20.

Here, as illustrated in FIG. 3, in the case in which the binding tape 22 is provided, the state in which the main body portion 12 and the auxiliary expandable portion 14 partially overlap each other is more firmly maintained.

Therefore, in such a state, the auxiliary expandable portion 14 is not detached and spaced apart from the main body portion 12, and the tray 10 is maintained to have a minimum volume necessary for accommodating contents, i.e., tofu (not illustrated) and brine.

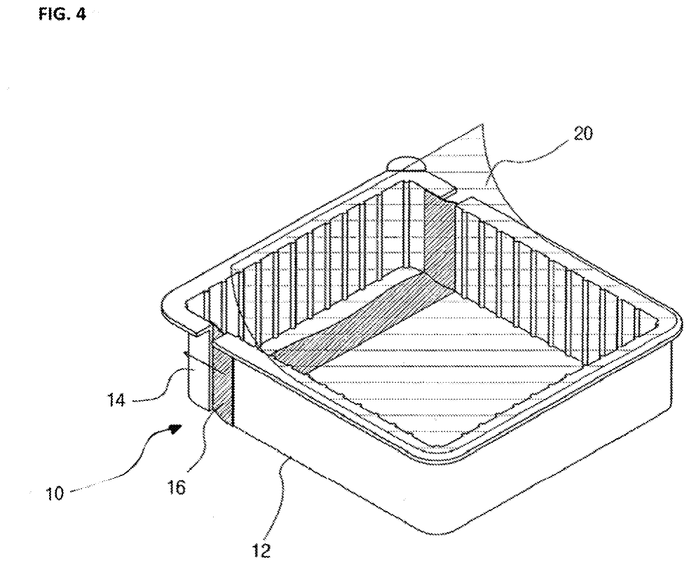

Then, as illustrated in FIG. 4, when the cover film 20 is removed entirely or partially to open the tray 10, since the binding state between the main body portion 12 and the auxiliary expandable portion 14 is released, when the auxiliary expandable portion 14 is pulled in this state, the auxiliary expandable portion 14 is detached and spaced apart from the main body portion 12, and the connecting film 16 is unfolded.

Here, although the auxiliary expandable portion 14 is detached and spaced apart from the main body portion 12, since the connecting film 16 is unfolded to correspond thereto, a gap that causes the brine to leak is not formed between the main body portion 12 and the auxiliary expandable portion 14, and the accommodation space of the tray 10 expands by as much as a distance at which the auxiliary expandable portion 14 is spaced apart from the main body portion 12.

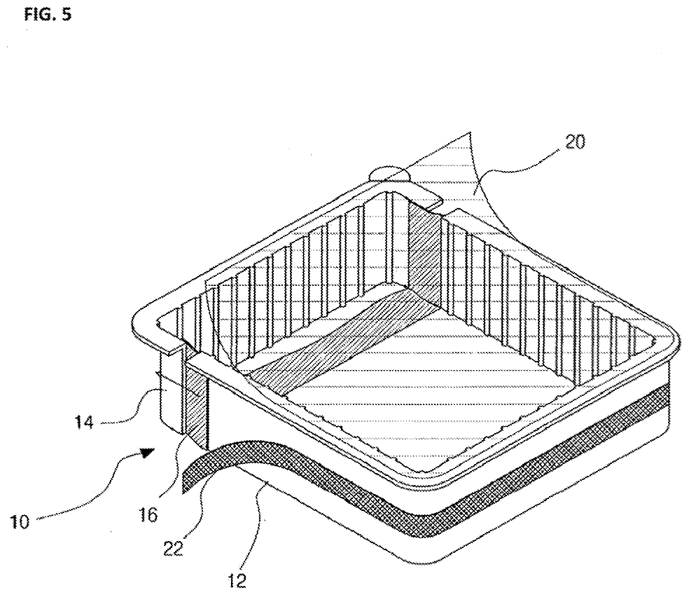

Also, in the case in which the variable food packaging container according to the first embodiment of the present invention includes the binding tape 22 as illustrated in FIG. 5, the binding tape 22 is also removed to release the binding state between the main body portion 12 and the auxiliary expandable portion 14.

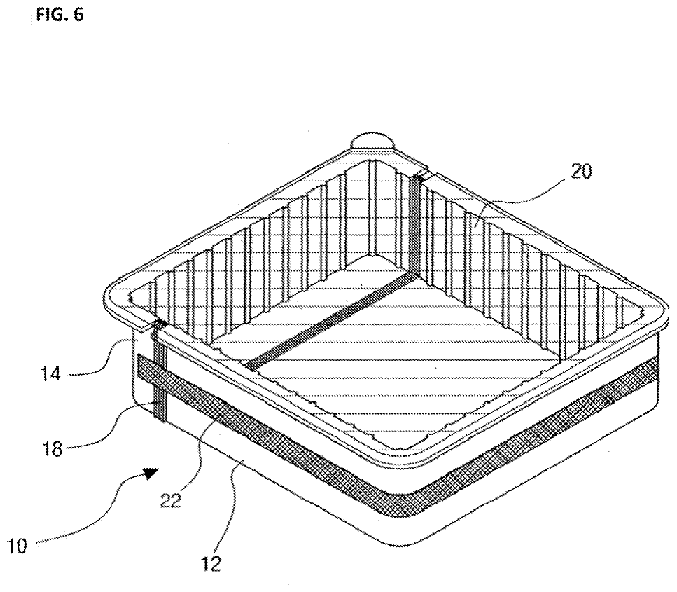

As illustrated in FIG. 6, in a variable food packaging container according to a second embodiment of the present invention, the connector is formed as a bellows connecting portion 18 configured in a form of continuing along both side surfaces and the bottom surface of the main body portion 12 and both side surfaces and the bottom surface of the auxiliary expandable portion 14.

Also, the variable food packaging container includes a binding tape 22 that binds the main body portion 12 and the auxiliary expandable portion 14 of the tray 10 to maintain a state in which the bellows connecting portion 18 is compressed.

For example, the binding tape 22 may be configured to be attached to the side surfaces of the main body portion 12 and the auxiliary expandable portion 14 of the tray 10.

Preferably, the bellows connecting portion 18 is integrally formed with the main body portion 12 and the auxiliary expandable portion 14, and a thickness of the bellows connecting portion 18 is smaller than that of the main body portion 12 and the auxiliary expandable portion 14 to allow flexible deformation of the bellows connecting portion 18.

The operation of the variable food packaging container according to the second embodiment of the present invention that is configured as described above will be described below.

First, in a state in which the tray 10 is not opened, the bellows connecting portion 18 maintains a compressed state due to the cover film 20 and the binding tape 22, and here, the tray 10 is maintained to have a minimum volume necessary for accommodating contents, i.e., tofu and brine (see FIG. 6).

Since the side surfaces of the main body portion 12 and the auxiliary expandable portion 14 of the tray 10 are also bound by the binding tape 22, the bellows connecting portion 18 is evenly compressed as a whole, and thus the main body portion 12 and the auxiliary expandable portion 14 maintain a predetermined distance therebetween as a whole.

Here, assuming that only the cover film 20 is used and thus only the upper surfaces of the main body portion 12 and the auxiliary expandable portion 14 are bound, since the bellows connecting portion 18 elastically expands downward, the upper ends of the main body portion 12 and the auxiliary expandable portion 14 may be close to each other while the lower ends thereof are spaced apart, and thus the tray 10 may be bent upward (not illustrated).

Consequently, when the tray 10 is bent upward from the bellows connecting portion 18, not only is it undesirable in terms of appearance, but also a problem such as poor stability may occur in a case in which the variable food packaging container is stacked vertically.

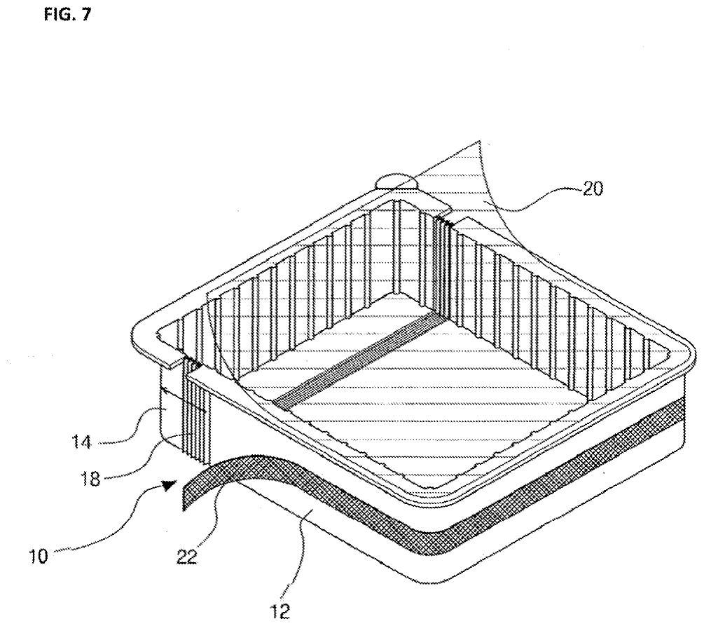

Then, as illustrated in FIG. 7, when the cover film 20 is removed entirely or partially to open the tray 10 and the binding tape 22 is also removed, since the binding state between the main body portion 12 and the auxiliary expandable portion 14 is released, when the auxiliary expandable portion 14 is slightly pulled in this state, the bellows connecting portion 18 is extended and the accommodation space of the tray 10 expands.

Therefore, according to the variable food packaging container according to each embodiment of the present invention, due to the characteristic that the accommodation space of the tray 10 is selectively expandable, there are the following advantages.

First, by expanding the accommodation space of the tray 10, contents such as tofu accommodated therein may be taken out without damage thereto.

Second, since the level of brine that the tray 10 is filled with is lowered, the contents may be taken out without causing overflow of the brine.

Third, since only a portion of the contents may be cut and easily taken out, the rest of the contents remaining in the tray 10 may be stored in an excellent condition while being held in the brine as before.

Fourth, since, before the tray 10 is opened, the accommodation space of the tray 10 is maintained to have a minimum volume necessary for storing the contents, efficiency of storage and transportation is not degraded.

Fifth, in a case in which only a portion of the contents is taken out of the tray 10 and the rest of the contents remain in the tray 10, the rest of the contents may be stored in a state in which the auxiliary expandable portion 14 is placed to partially overlap the main body portion 12 again to reduce the accommodation space of the tray 10, and here, the binding tape 22 may be attached again to firmly maintain the state in which the auxiliary expandable portion 14 and the main body portion 12 partially overlap each other.

In the embodiments of the present invention described above, tofu has been mentioned as an example of contents to be packaged, but note that the variable food packaging container according to the present invention is not limited to being applied to packaging tofu and may also be applied to packaging other soft foods such as jelly or cheese and various other forms of food.

1. A variable food packaging container comprising:
a tray including a main body portion that has a form in which one side surface is open, an auxiliary expandable portion that is combined with the open one side surface of the main body portion so as to be able to be spaced apart therefrom and to form a single accommodation space therewith, and a connector that allows the main body portion and the auxiliary expandable portion to be connected to each other so as to be able to be spaced apart from each other; and
a cover film attached to the tray to cover the accommodation space,
wherein the main body portion and the auxiliary expandable portion of the tray are combined in a form of partially overlapping each other,
in a state in which the main body portion and the auxiliary expandable portion partially overlap each other, the overlapping state is maintained by the cover film, and
the auxiliary expandable portion is able to be spaced apart from the main body portion only when the cover film is removed, and a size of the accommodation space of the tray changes when the auxiliary expandable portion is spaced apart from the main body portion.

2. The variable food packaging container of claim 1, wherein the connector is formed as a connecting film that is attached in a form of continuing along both side surfaces and a bottom surface of the main body portion and both side surfaces and a bottom surface of the auxiliary expandable portion, is folded in the state in which the main body portion and the auxiliary expandable portion partially overlap each other, and is unfolded when the auxiliary expandable portion is spaced apart from the main body portion to maintain a state in which the main body portion and the auxiliary expandable portion are connected.

3. The variable food packaging container of claim 2, comprising a binding tape that is attached to bind the main body portion and the auxiliary expandable portion to maintain the state in which the main body portion and the auxiliary expandable portion are combined while partially overlapping each other.

4. The variable food packaging container of claim 1, wherein the connector is formed as a bellows connecting portion configured in a form of continuing along both side surfaces and a bottom surface of the main body portion and both side surfaces and a bottom surface of the auxiliary expandable portion.

5. The variable food packaging container of claim 4, comprising a binding tape that is attached to bind the main body portion and the auxiliary expandable portion to maintain a state in which the bellows connecting portion is compressed.
